(19) United States
(12) Patent Application Publication
(10) Pub. No.: US 2025/0298216 A1
(43) Pub. Date: Sep. 25, 2025

(54) LENS APPARATUS AND IMAGE PICKUP APPARATUS

(71) Applicant: CANON KABUSHIKI KAISHA, Tokyo (JP)

(72) Inventors: Kota ASANO, Tochigi (JP); Katsuhiko SATO, Tochigi (JP); Koji SATO, Tochigi (JP)

(21) Appl. No.: 19/231,639

(22) Filed: Jun. 9, 2025

Related U.S. Application Data
(63) Continuation of application No. PCT/JP2023/036140, filed on Oct. 4, 2023.

(30) Foreign Application Priority Data
Dec. 16, 2022 (JP) 2022-200902

(51) Int. Cl. G02B 7/10

(52) U.S. Cl. CPC G02B 7/102

(57) ABSTRACT

A lens apparatus includes a first holder holding a first lens unit, a second holder holding a second lens unit and movable together with the second lens unit, and a drive unit configured to drive the second holder in the optical axis direction. The drive unit includes a first drive member including a first coil, and a second drive member including a second coil. In the optical axis direction, a first end closest to an object of the drive unit is located at the same position as a position of a second end closest to the object of the second holder, or a position on the image side of the second end. A position of an end closest to the object of the first coil and a position of an end closest to the object of the second coil are different in the optical axis direction.

### CROSS-REFERENCE TO RELATED APPLICATIONS

This application is a Continuation of International Patent Application No. PCT/JP2023/036140, filed on Oct. 4, 2023, which claims the benefit of Japanese Patent Application No. 2022-200902, filed on Dec. 16, 2022, both of which are hereby incorporated by reference herein in their entirety.

### BACKGROUND

### Technical Field

The present disclosure relates to a lens apparatus and an image pickup apparatus.

### Description of Related Art

Japanese Patent Application Laid-Open No. 2013-83775 discloses a lens apparatus having an optical system consisting of five lens units, namely, in order from the object side to the image side, a first lens unit, a second lens unit, a third lens unit, a fourth lens unit, and a fifth lens unit.

### SUMMARY

A lens apparatus according to one aspect of the disclosure includes a plurality of lens units consisting of, in order from an object side to an image side, a first lens unit, a second lens unit, and a rear lens unit, a first holder holding the first lens unit, a second holder holding the second lens unit and movable together with the second lens unit in an optical axis direction, and a drive unit configured to drive the second holder in the optical axis direction. During zooming from a wide-angle end to a telephoto end, a distance between adjacent lens units in the plurality of lens units changes. In the optical axis direction, a first end closest to an object of the drive unit is located at the same position as a position of a second end closest to the object of the second holder, or a position on the image side of the second end. A position of an end closest to the object of the first coil and a position of an end closest to the object of the second coil are different in the optical axis direction. An image pickup apparatus having the above lens apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a lens apparatus in a first embodiment.

FIG. 2 is a sectional view of a lens apparatus in a second embodiment.

FIG. 3 is a sectional view of a lens apparatus in a third embodiment.

FIG. 4 is a schematic diagram of an image pickup apparatus according to each embodiment.

### DETAILED DESCRIPTION

Referring now to the accompanying drawings, a detailed description will be given of embodiments according to the disclosure.

### First Embodiment

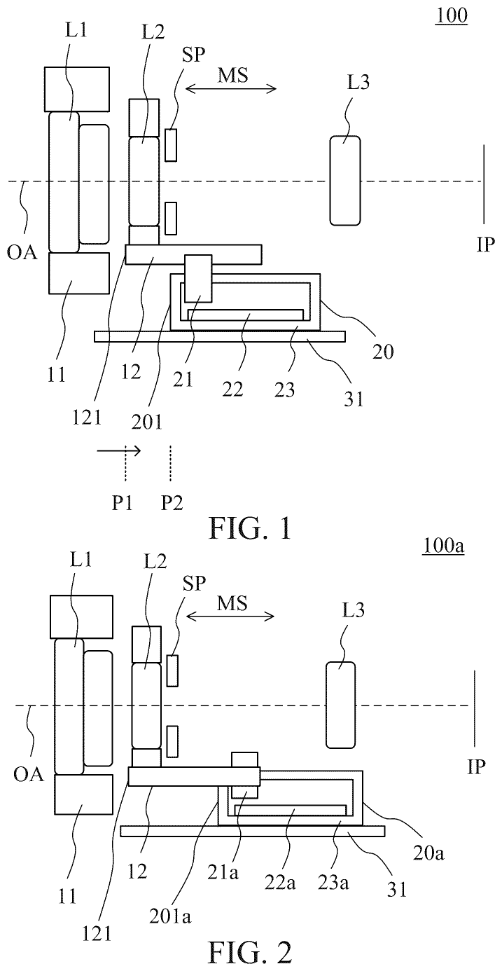

Referring now to FIG. 1, a description will be given of a lens apparatus 100 according to a first embodiment of the present disclosure. FIG. 1 is a sectional view of the lens apparatus 100. In FIG. 1, a left side is an object side, and a right side is an image side. FIG. 1 illustrates only the configuration directly related to the description of this embodiment, and omits the configuration not directly related to the description of this embodiment.

The lens apparatus 100 includes a plurality of lens units (imaging optical system) consisting of a first lens unit L1, a second lens unit L2, and a rear lens unit, arranged in this order from the object side to the image side. An optical image formed by the plurality of lens units is formed on an image plane IP. FIG. 1 illustrates only the third lens unit L3 disposed adjacent to the second lens unit L2 on the image side of the second lens unit L2 as the rear lens unit, but this embodiment is not limited to this example. As long as the rear lens unit includes at least the third lens unit L3, it may further include at least one lens unit on the image side of the third lens unit L3. The lens unit may include one or more lens.

During zooming from the wide-angle end to the telephoto end, a distance between adjacent lens units in the plurality of lens units changes. In this embodiment, the second lens unit L2 moves in a direction along the optical axis OA (optical axis direction) with a moving stroke MS indicated by an arrow in FIG. 1 during zooming. In this embodiment, the first lens unit L1 does not move during zooming. That is, the overall lens length (the length on the optical axis from a lens surface closest to the object to a lens surface closest to the image plane of the plurality of lens units constituting the imaging optical system plus the back focus) does not change (overall length fixed). In this embodiment, the lens apparatus 100 has an aperture stop (diaphragm) SP that moves together with the second lens unit L2, but this embodiment is not limited to this example.

A first holding frame (first holder) 11 holds the first lens unit L1. A second holding frame (second holder) 12 holds the second lens unit L2 and moves together with the second lens unit L2 in the optical axis direction. In the radial direction, the second holding frame 12 is smaller than the first holding frame 11. A voice coil motor (drive unit) 20 is connected to the second holding frame 12 and is configured to be able to transmit a driving force to the second holding frame 12, thereby driving the second holding frame 12 in the optical axis direction. The lens apparatus 100 is capable of electric zooming, and the voice coil motor 20 drives the second holding frame 12 by control based on the user's operation or user's instruction.

The voice coil motor 20 includes a coil 21, a magnet 22, and a yoke 23. The coil 21 is integrated with the second holding frame 12. The magnet 22 and the yoke 23 are provided in the lens barrel 31, and form a magnetic field to move the coil 21.

In the lens apparatus 100, in order to drive the second lens unit L2 with the voice coil motor 20, the coil 21, the magnet 22, and the yoke 23 are to be disposed near the second lens unit L2. Since the magnet 22 and the yoke 23 are large, they may interfere (contact or collide) with, for example, the first lens unit L1 or the first holding frame 11 during zooming. An attempt to retract the voice coil motor 20 in a direction (radial direction) away from the optical axis OA to avoid interference may increase the size of the lens apparatus 100.

Accordingly, this embodiment sets a positional relationship between the second holding frame 12 and the voice coil motor 20 in the optical axis direction so as to avoid interference between the first holding frame 11 and the voice coil motor 20. That is, in this embodiment, a front end 201 of the voice coil motor 20 (a first end closest to the object of the voice coil motor 20) is disposed at a position P2 on the image side of the position P1 of a front end 121 of the second holding frame 12 (a second end closest to the object of the second holding frame 12). However, this embodiment is not limited to this example, and the front end 201 of the voice coil motor 20 may be located at the same position (P1=P2) as the position P1 of the front end 121 of the second holding frame 12 in the optical axis direction. In other words, the front end 201 of the voice coil motor 20 does not protrude on the object side of the front end 121 of the second holding frame 12.

Due to this configuration, even when the second lens unit L2 moves in the optical axis direction during zooming, the size of the lens apparatus 100 can be reduced while the voice coil motor 20 is avoided from interfering with the first lens unit L1 or the first holding frame 11. This embodiment places the voice coil motor 20 outside the second holding frame 12, and can reduce the size of the lens apparatus 100 in the radial direction, i.e., in the direction orthogonal to the optical axis OA (direction orthogonal to the optical axis).

In this embodiment, the length from the outermost end to the innermost end in the radial direction (direction perpendicular to the optical axis direction) of the yoke 23 is shorter than the length in the optical axis direction from the end closest to the object to the end closest to the image plane of the yoke 23. This configuration can reduce the size of the lens apparatus 100 in the radial direction.

### Second Embodiment

Referring now to FIG. 2, a description will be given of a lens apparatus 100a according to a second embodiment of the present disclosure. FIG. 2 is a sectional view of the lens apparatus 100a. In FIG. 2, a left side is an object side, and a right side is an image side. As in FIG. 1, FIG. 2 illustrates only the configuration directly related to the description of this embodiment, and omits configurations not directly related to the description of this embodiment.

The lens apparatus 100a according to this embodiment differs from the lens apparatus 100 according to the first embodiment in that it includes a voice coil motor 20a instead of the voice coil motor 20. Other configurations and operations of the lens apparatus 100a are similar to those of the lens apparatus 100, and thus a description thereof will be omitted.

The voice coil motor 20a includes a coil 21a, a magnet 22a, and a yoke 23a, and is disposed behind (on the image side of) the second holding frame 12 that holds the second lens unit L2. That is, when viewed from the object side to the image side in the optical axis direction (when the lens apparatus 100a is viewed from the front), at least a part of each of the coil 21a, magnet 22a, and yoke 23a of the voice coil motor 20a and at least a part of the second holding frame 12 overlap each other. In this embodiment, the front end 201a of the voice coil motor 20a (the first end closest to the object of the voice coil motor 20a) is disposed at a position on the image side of the front end 121 of the second holding frame 12 (the second end closest to the object of the second holding frame 12).

Due to this configuration, even when the second lens unit L2 moves in the optical axis direction during zooming, the size of the lens apparatus 100a can be reduced while the voice coil motor 20a can be prevented from interfering with the first lens unit L1 or the first holding frame 11. This embodiment places the voice coil motor 20a on the image side of the second holding frame 12, and can reduce the size of the lens apparatus 100a in the optical axis direction.

In this embodiment, when viewed in the optical axis direction from the object side to the image side, at least a part of the voice coil motor 20a and at least a part of the first holding frame 11 overlap each other. This configuration can reduce the size of the lens apparatus 100a in the radial direction.

### Third Embodiment

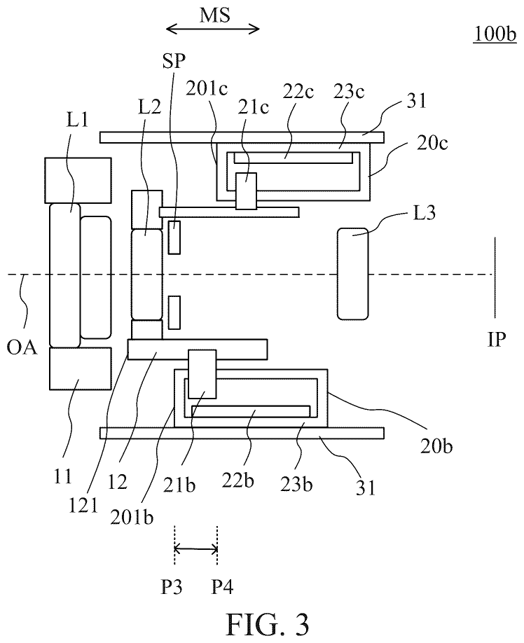

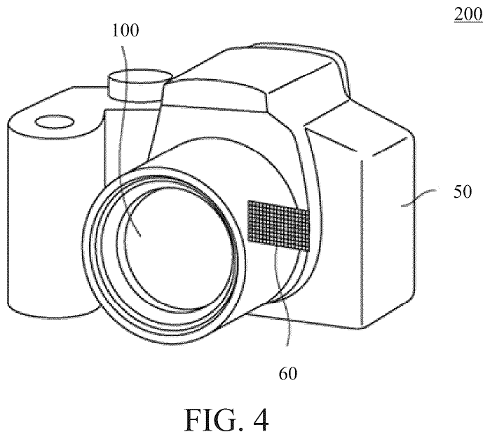

Referring now to FIG. 3, a description will be given of a lens apparatus 100b according to a third embodiment of the present disclosure. FIG. 3 is a sectional view of the lens apparatus 100b. In FIG. 3, a left side is an object side, and a right side is an image side. As in FIG. 1, FIG. 3 illustrates only the configuration directly related to the description of this embodiment, and omits the configuration not directly related to the description according to this embodiment.

The lens apparatus 100b according to this embodiment is different from the lens apparatus 100 of the first embodiment having only one voice coil motor in that it includes a first voice coil motor (first driving member) 20b and a second voice coil motor (second driving member) 20c as a drive unit. However, this embodiment is not limited to a configuration having two voice coil motors, and can also be applied to a configuration having three or more voice coil motors. In this embodiment, the two voice coil motors are a common motor, but this embodiment is not limited to this example, and can also be applied to two motors with different characteristics and sizes. Other configurations and operations of the lens apparatus 100b are similar to those of the lens apparatus 100, and thus a description thereof will be omitted.

The first voice coil motor 20b includes a coil 21b, a magnet 22b, and a yoke 23b, and is disposed outside the second holding frame 12 that holds the second lens unit L2. Similarly, the second voice coil motor 20c includes a coil 21c, a magnet 22c, and a yoke 23c, and is disposed outside the second holding frame 12 that holds the second lens unit L2.

In addition, the front end 201b of the first voice coil motor 20b (the first end (third end) closest to the object of the first voice coil motor 20b) is placed at a position on the image side of the position of the front end 121 of the second holding frame 12 (the second end closest to the object of the second holding frame 12). Similarly, the front end 201c of the second voice coil motor 20c (the first end (fourth end) closest to the object of the second voice coil motor 20c) is disposed at a position on the image side of the position of the front end 121 of the second holding frame 12.

In this embodiment, in the optical axis direction, a position P3 of the third end (front end 201b) closest to the object of the first voice coil motor 20b and a position P4 of the fourth end (front end 202c) closest to the object of the second voice coil motor 20c are different from each other. That is, the positions P3 and P4 do not coincide with each other in the optical axis direction.

In a case where the second lens unit L2 is heavyweight, etc., the second holding frame 12 may be driven using a plurality of voice coil motors rather than using a single voice coil motor. In a case where a plurality of voice coil motors are disposed, the possibility of interference with other parts on the object side and image side of the second holding frame 12 and other parts outside (radially) the second holding frame 12 is further increased. Shifting the positions of the plurality of voice coil motors in the optical axis direction as in this embodiment can improve the degree of freedom in component placement.

In this embodiment, the first voice coil motor 20b and the second voice coil motor 20c are placed at different positions in the optical axis direction, so the balance of the Lorentz forces is shifted. Therefore, in a case where the center of gravity of the second holding frame 12 is not on the optical axis OA (center) because the second holding frame 12 is asymmetrical in shape, shifting the positions of the two voice coil motors can provide well-balanced driving.

Referring now to FIG. 4, a description will be given of an image pickup apparatus 200 equipped with the lens apparatus 100 (100a, 100b) according to each embodiment. FIG. 4 is a schematic diagram of the image pickup apparatus 200.

In FIG. 4, reference numeral 50 denotes a camera body, and reference numeral 11 denotes the lens apparatus 100 (100a, 100b) according to any one of the first to third embodiments. Reference numeral 60 denotes an image sensor (photoelectric conversion element) such as a CMOS sensor or CCD sensor that is built into the camera body 50 and receives and photoelectrically converts an optical image formed by the optical system in the lens apparatus 100. The camera body 50 may be either a so-called single-lens reflex camera having a quick-turn mirror, or a so-called mirrorless camera having no quick-turn mirror. The lens apparatus according to each embodiment is applicable not only to digital still cameras, but also to other image pickup apparatus such as video cameras.

Each embodiment can provide a lens apparatus and image pickup apparatus, each of which has a reduced size.

While the disclosure has described example embodiments, it is to be understood that the disclosure is not limited to the example embodiments. The scope of the following claims is to be accorded the broadest interpretation so as to encompass all such modifications and equivalent structures and functions.

What is claimed is:

1. A lens apparatus comprising:
a plurality of lens units consisting of, in order from an object side to an image side, a first lens unit, a second lens unit, and a rear lens unit;
a first holder holding the first lens unit;
a second holder holding the second lens unit and movable together with the second lens unit in an optical axis direction; and
a drive unit configured to drive the second holder in the optical axis direction,
wherein the drive unit includes a first drive member including a first coil, and a second drive member including a second coil,
wherein in the optical axis direction, a first end closest to an object of the drive unit is located at the same position as a position of a second end closest to the object of the second holder, or a position on the image side of the second end, and
wherein a position of an end closest to the object of the first coil and a position of an end closest to the object of the second coil are different in the optical axis direction.

2. The lens apparatus according to claim 1, wherein the drive unit includes a voice coil motor, and a magnet and a yoke for forming a magnetic field to move the first coil.

3. The lens apparatus according to claim 2, wherein when viewed from the object side to the image side in the optical axis direction, at least a part of each of the first coil, the magnet, and the yoke of the drive unit and at least a part of the second holder overlap each other.

4. The lens apparatus according to claim 1, wherein when viewed from the object side to the image side in the optical axis direction, at least a part of the drive unit and at least a part of the first holder overlap each other.

5. The lens apparatus according to claim 1, wherein in the optical axis direction, a position of a third end closest to the object of the first driving member and a position of a fourth end closest to the object of the second driving member are different from each other.

6. The lens apparatus according to claim 1, wherein the rear lens unit includes at least a third lens unit disposed on the image side of the second lens unit.

7. The lens apparatus according to claim 2, wherein a length from an outermost end to an innermost end of the yoke in a radial direction, which is a direction perpendicular to the optical axis direction, is shorter than a length in the optical axis direction from an end closest to the object of the yoke to an end closest to an image plane.

8. The lens apparatus according to claim 1, wherein the second holder is smaller than the first holder in a radial direction.

9. An image pickup apparatus comprising:
a lens apparatus; and
an image sensor;
wherein the lens apparatus includes:
a plurality of lens units consisting of, in order from an object side to an image side, a first lens unit, a second lens unit, and a rear lens unit,
a first holder holding the first lens unit,
a second holder holding the second lens unit and movable together with the second lens unit in an optical axis direction, and
a drive unit configured to drive the second holder in the optical axis direction,
wherein the drive unit includes a first drive member including a first coil, and a second drive member including a second coil,
wherein in the optical axis direction, a first end closest to the object of the drive unit is located at the same position as a position of a second end closest to the object of the second holder, or a position on the image side of the second end, and
wherein a position of an end closest to an object of the first coil and a position of an end closest to the object of the second coil are different in the optical axis direction.
